(19) United States
(12) Patent Application Publication
(10) Pub. No.: US 2026/0112098 A1
(43) Pub. Date: Apr. 23, 2026

(54) AR Ecosystem

(71) Applicant: Sheila Harding, Spencer, OK (US)

(72) Inventor: Sheila Harding, Spencer, OK (US)

(21) Appl. No.: 19/363,641

(22) Filed: Oct. 20, 2025

Related U.S. Application Data
(60) Provisional application No. 63/709,321, filed on Oct. 18, 2024.

(51) Int. Cl. G06T 13/40; G06F 3/01; G06F 8/34; G06F 40/30; G06T 17/20; G06T 19/00; H04L 9/40

(52) U.S. Cl. CPC G06T 13/40; G06F 8/34; G06T 17/20; G06T 19/003; G06T 19/006; H04L 63/083; G06F 3/016; G06F 40/30; G06T 2200/24; G06T 2210/08; G06T 2210/56; G06T 2219/024

(57) ABSTRACT

A spatially aware avatar platform integrates environmental mapping, behavioral intelligence, and modular development tools to enable adaptive interaction in augmented and mixed-reality environments. The system combines LiDAR-based spatial processing, geospatial pathway management, language-model-driven behavior generation, and sensor fusion to produce context-aware avatars capable of perceiving and responding to real-world conditions. A modular SDK supports integration with third-party sensors, haptic devices, and rendering engines through secure, versioned interfaces. The platform further provides real-time visualization of sensor data and synchronized haptic feedback to enhance situational awareness in industrial, educational, and defense applications.

### CROSS-REFERENCE TO RELATED APPLICATIONS

This application may claim priority to one or more provisional or non-provisional applications, the disclosures of which may be incorporated herein by reference in their entirety.

### FIELD OF THE DISCLOSURE

The present disclosure relates generally to augmented-and mixed-reality systems, and may relate more particularly to platforms that enable an AR Ecosystem.

### BACKGROUND

Conventional augmented-reality (AR) and mixed-reality (MR) systems may primarily focus on overlaying static visual content on physical environments. Although advances in spatial computing and depth sensing may improve realism, existing frameworks may still lack mechanisms for dynamic avatar interaction that respond to environmental, contextual, and linguistic cues.

Many current systems may treat spatial data, behavioral artificial intelligence, and environmental sensing as independent subsystems, resulting in inconsistent context alignment and discontinuous user experiences. Language-model-based avatars may generate dialogue or actions disconnected from the user's immediate surroundings, while scene-mapping systems may not interpret intent or narrative progression.

Developers may also face challenges in creating cross-platform experiences that integrate diverse sensors, behavioral models, and networked devices. Existing SDKs may provide limited interoperability, forcing teams to maintain separate pipelines for AR rendering, AI inference, and sensor management.

Accordingly, there may be a need for a unified architecture that integrates environmental awareness, behavioral intelligence, and modular development tools, enabling avatars and virtual entities to perceive, interpret, and interact with real-world conditions in real time.

### SUMMARY

The disclosed system may provide an integrated platform for supporting an AR Ecosystem. The system may unify environmental scanning, behavioral intelligence, and developer tooling to create persistent, context-responsive AR experiences.

In various embodiments, the system may comprise a Spatial Processing Module configured to capture three-dimensional environmental data and generate a navigation mesh and semantic map; a Pathway Engine that may define linked scenes with triggers and contextual transitions; a Motion Graph Engine that may orchestrate avatar locomotion and animation blending; a Behavioral Controller that may interface with a language-model gateway for natural-language understanding and decision-making; a Sensor Fusion Module that may integrate heterogeneous data sources; and an SDK Hub that may manage third-party module integration, permissions, and versioning.

The system may enable avatars to interpret environmental geometry, user intent, and sensor telemetry in real time, producing synchronized audiovisual and haptic feedback. Developers may author and publish interactive pathways using graphical SDK tools, while runtime environments may support single-or multi-user sessions across mobile, desktop, and headset devices.

### BRIEF DESCRIPTION OF THE DRAWINGS

FIG. 1 illustrates a high-level architecture of the spatially aware avatar platform.

FIG. 2 is a flow diagram illustrating a representative spatial mapping workflow implemented by the AR Ecosystem

FIG. 3 illustrates a representative Pathway Engine model depicting a set of linked scenes and conditional transitions.

FIG. 4 illustrates a Behavioral Controller integration model.

FIG. 5 is a block diagram illustrating an example of a sensor-fusion arrangement.

FIG. 6 is a block diagram illustrating an example of a system capable of supporting AR Ecosystems, according to one embodiment.

FIG. 7 is a component diagram of a computing device that may support AR Ecosystems, according to one embodiment.

### DETAILED DESCRIPTION

The system described herein may integrate spatial computation, natural-language-driven behavior, and multimodal sensing to create adaptive augmented-reality experiences.

Components may be rearranged, combined, or implemented as hardware, software, or hybrid systems without departing from the disclosure.

### System Architecture Overview

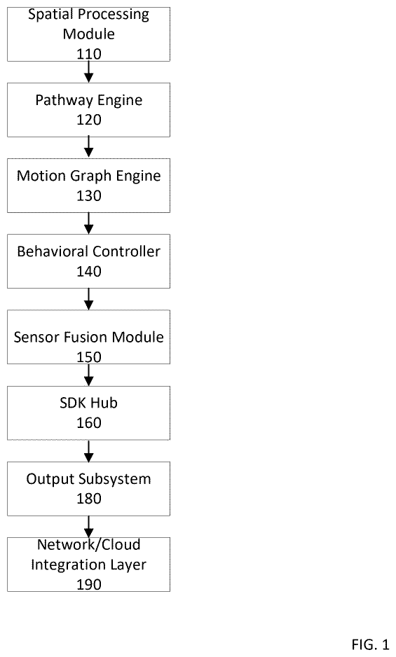

FIG. 1 is a block diagram illustrating an example configuration of AR Ecosystem 100.

AR Ecosystem 100 may include Spatial Processing Module 110 configured to capture three-dimensional environmental data and to generate a navigation mesh. Spatial Processing Module 110 may communicate environmental information to Pathway Engine 120 that may define contextual scene transitions and triggers. Pathway Engine 120 may, in turn, provide spatial and contextual cues to a Motion Graph Engine 130, which may control avatar locomotion and animation blending. A Behavioral Controller 140 may interpret natural-language inputs or environmental metadata to determine avatar behavior and may issue control instructions to the Motion Graph Engine 130. Sensor Fusion Module 150 may receive data from heterogeneous sensors—including cameras, depth sensors, inertial units, or beacons—and may align them into a unified coordinate system shared with the Spatial Processing Module 110. The SDK Hub 160 may manage inter-module communication, developer integration, authentication, and runtime configuration. Data Flow Interfaces 170 may represent the bidirectional exchange of information among modules, while an Output Subsystem 180 may render synchronized visual, auditory, and haptic feedback to a user device. Optionally, a Network Integration Layer 190 may link multiple instances of the system 100 across devices or cloud services for multi-user synchronization.

The platform may include a Spatial Processing Module, Pathway Engine, Motion Graph Engine, Behavioral Controller, Sensor Fusion Module, and SDK Hub. Each module may communicate through event-driven interfaces that may permit distributed execution across client, edge, and cloud environments.

The Spatial Processing Module may capture real-world geometry using LiDAR, depth cameras, stereo imaging, or other sensors, and may generate a navigation mesh and semantic map, labeling objects and surfaces.

The Pathway Engine may maintain a collection of linked augmented-reality scenes called pathways. Each pathway may define spatial triggers, environmental conditions, and contextual transitions.

The Motion Graph Engine may determine avatar locomotion and animation blending, planning trajectories that conform to environmental geometry while maintaining natural transitions among motion states.

The Behavioral Controller may interface with a language-model gateway capable of interpreting natural-language dialogue, environmental metadata, and sensor inputs to infer user intent and generate contextual responses.

The Sensor Fusion Module may aggregate and align data from multiple sources—such as inertial units, beacons, environmental monitors, and wearable devices—within a unified spatial reference frame.

The SDK Hub may provide an extensible development environment that supports module registration, secure API access, versioning, and plugin discovery. Developers may use graphical tools to author pathways, simulate behaviors, and deploy experiences to supported devices.

### Spatial Processing Module

The Spatial Processing Module may construct a digital representation of a physical environment by combining multiple sensor modalities. Depth frames may be fused into a point cloud that may be meshed using Delaunay triangulation, voxel-based reconstruction, or other surface-generation techniques. Machine-learning models may perform semantic segmentation to identify objects such as floors, walls, and furniture.

A compression layer may reduce data size for transmission, and an anchor manager may associate virtual coordinate systems with persistent physical reference points. When a user revisits a mapped space, stored anchors may be reloaded to maintain sub-centimeter alignment between digital and physical coordinates.

Predictive asset streaming may anticipate user movement by estimating paths based on velocity and prior navigation behavior. As the user approaches a new region, the module may preload corresponding geometry and textures to maintain seamless transitions.

### Pathway Engine

The Pathway Engine may define spatial and logical relationships between scenes. Each pathway may include nodes linked by directional edges, each node corresponding to a distinct region or state, and each edge defining a trigger condition for transition.

Triggers may include motion through a geofence, elapsed time, completion of a task, or recognition of a spoken command. Context variables such as user progress, dialogue history, or environmental conditions may persist across nodes.

A finite-state machine or rule-based controller may ensure transitions occur only when preconditions are met. Probabilistic models may support non-linear progression for varied experiences across sessions.

### Motion Graph Engine

The Motion Graph Engine may translate semantic intent into motion behavior. Each animation primitive may be stored as a node in a graph whose edges may encode permitted transitions. The system may select optimal transitions based on terrain data, posture, and intent.

A reinforcement-learning process may adjust transition weights according to feedback from physics or perceptual metrics, improving smoothness over time. The Motion Graph Engine may also adjust gait or stride length to accommodate slopes or obstacles.

### Behavioral Controller

The Behavioral Controller may coordinate avatar reasoning, dialogue, and response execution. It may transmit contextual prompts to a language-model inference service and may receive predicted actions or utterances.

Each prompt may include environmental descriptors, recent dialogue, gaze direction, gesture classification, and local sensor data. The output may be parsed into an intent vector determining avatar state.

The Behavioral Controller may trigger gestures, facial expressions, and voice synthesis according to this intent and may maintain a persistent memory record for continuity. Multiple avatars may synchronize their states across a network by comparing timestamps and priority levels.

### Sensor Fusion Module

The Sensor Fusion Module may integrate heterogeneous data sources into a single spatial reference frame. Inputs may include LiDAR depth, stereo imagery, IMUs, ultrasonic sensors, and radio beacons. Each input may be timestamped and registered through transformation matrices and temporal interpolation.

Calibration may be performed dynamically or at startup. Spatial calibration may rely on fiducial markers or iterative closest-point algorithms; temporal calibration may align clocks within two milliseconds. Error estimates may be tracked and used for weighting; predictive interpolation may sustain continuity when data are lost.

APIs may allow third-party sensors to register with the SDK Hub by submitting calibration profiles and schema manifests.

### Sdk Hub

The SDK Hub may manage module registration, version control, and secure communication. Each module may declare a manifest listing supported interfaces and permissions. The SDK Hub may validate manifests and translate inter-module messages into standardized events so that modules written in different languages may interoperate.

A graphical authoring interface may allow drag-and-drop assembly of scenes, triggers, and behavior trees. Developers may preview experiences in a live simulator and compile distributable experience packages signed for authenticity and uploaded to a discovery service.

Encrypted communication, rotating tokens, and audit logs may safeguard module integrity.

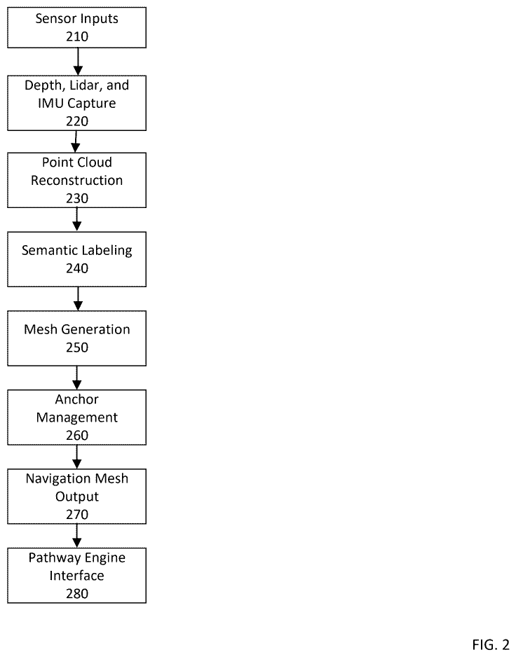

System Synchronization and Data Flow FIG. 2 is a flow diagram illustrating a representative spatial mapping workflow 200 implemented by the AR Ecosystem. The workflow 200 may begin with Sensor Inputs 210 comprising LiDAR, Stereo Camera, or Inertial Measurement Units that capture real-world geometry. Depth, LiDAR, and Inertial Measurement Unit (IMU) Capture module 220 may process these inputs to produce normalized depth maps and raw point-cloud data. Point Cloud Reconstruction Module 230 may merge consecutive frames into a cohesive spatial dataset. Semantic Labeling 240 may assign object categories—such as walls, floors, or furniture—using trained segmentation models or rule-based classification. Mesh Generation Module 250 may convert the labeled point cloud into a polygonal surface mesh suitable for navigation and rendering. Anchor Management module 260 may define persistent anchor points corresponding to fixed real-world features, enabling re-localization between sessions. Navigation Mesh Output 270 may describe walkable regions and obstacles and may be provided to Pathway Engine Interface 280, which may enable dynamic scene and pathway construction based on environmental geometry.

The system may operate through asynchronous message channels. Sensor data, AI inferences, and user events may be serialized and timestamped. A synchronization layer may align multimodal outputs—visual, auditory, and haptic—within a ten-to thirty-millisecond window.

Predictive modeling may anticipate user actions several frames ahead to mask latency. Clock alignment may rely on NTP or PTP synchronization across devices.

### Error Handling and Redundancy

Modules may emit heartbeat signals monitored by the SDK Hub. On timeout, a failover procedure may activate redundant modules or cached data. Predictive recovery routines may estimate missing sensor data or trigger fallback AI models when network access is lost.

Fault logs may be aggregated for analytics and predictive maintenance.

### Performance Optimization

The system may adapt rendering fidelity, LOD complexity, and sensor rates according to resource load. Assets with higher relevance may be preloaded, while low-priority ones may stream later. Sensor sampling and AI inference rates may scale dynamically to balance power and responsiveness.

### Developer Toolchain and Authoring Workflow

The SDK Hub may include visual editors, timeline controls, and simulation tools for testing. Validation utilities may check dependencies; a CI pipeline may run regression tests. Compiled experience packages may include manifests, assets, and signed metadata for secure deployment.

### Multi-User Networking

Multiple users may share synchronized environments. Each device may maintain a local replica of the pathway state and exchange differential updates. Conflicts may be resolved via timestamp and confidence weighting. Cloud-edge orchestration may balance workloads between devices and remote servers.

### Sensor Calibration and Alignment

Sensors may align spatially and temporally to a global coordinate frame using transformation matrices. Self-calibration routines may refine alignment over time using observed motion and feedback.

### Security and Access Control

Encrypted channels, token-scoped permissions, sandboxed classified modules, and immutable audit logs may secure communications and operations.

### Performance Adaptation and Resource Scaling

Performance monitors may track frame time and resource load, invoking adaptive LOD, temporal upscaling, or distributed compute allocation to maintain responsiveness.

### Developer Ecosystem

Authoring tools may allow node-based design, live debugging, and sandboxed scripting. The SDK Hub may compile and sign packages for marketplace or private distribution.

### Runtime Temporal Synchronization

A global clock may coordinate multimodal events. Predictive motion correction and interpolation may maintain continuity even under network delay. Multi-user synchronization may ensure shared timing across heterogeneous devices.

### Searchable Database of Place-Based Experiences

The system may include a searchable database or marketplace of place-based augmented reality experiences. The database may be publicly accessible and may provide a cataloged index of immersive experiences that are geographically anchored to real-world locations. Each entry in the database may correspond to a distinct augmented reality pathway, scene, or event that has been generated through the platform's authoring and deployment tools.

Users may browse, search, or filter the catalog using a variety of criteria, such as geographic region, content type, creator identity, rating, popularity, or thematic tags. The interface may present a combination of textual, visual, and audiovisual information describing each experience, such as creator profiles, thumbnails, demonstration videos, or representative still frames from the augmented scenes. Upon selecting a listing, a user may receive navigation guidance to the real-world location associated with that experience.

The marketplace function may allow content creators to register, describe, and publish their augmented reality pathways. Each listing may include metadata defining spatial boundaries, system requirements, and optional monetization terms such as ticketing or sponsorship data. The database may also support a rating and review system in which participants provide qualitative or quantitative feedback, which may in turn inform recommendation algorithms for future users.

In certain embodiments, the system may include geofencing logic configured to detect when a user is within proximity of a listed experience. When a user device enters a geofenced zone, the system may issue a notification indicating that an augmented reality pathway is available nearby. The notification may include options for previewing, downloading, or initiating navigation toward the experience. This mechanism may promote discovery of place-based experiences while maintaining spatial relevance to the user's current environment.

The searchable database and geofenced discovery features may operate in conjunction with the broader spatial mapping and pathway engines described herein. For example, listings in the database may reference the same coordinate system used by the Pathway Engine, allowing seamless alignment between public listings, local navigation, and avatar rendering. The integration of a discovery marketplace within the same technical framework may further enable persistent, interconnected augmented reality ecosystems that evolve based on user participation and spatial context.

### Database Architecture and Indexing Logic

The searchable database may be implemented as a structured or semi-structured data repository accessible through the SDK Hub and network integration layers of the system. Each entry in the database may correspond to a record representing a specific augmented reality experience, identified by a unique experience identifier ID and associated metadata schema. The metadata may include fields for geospatial coordinates, author identifiers, media references, version control tags, and visibility parameters.

The indexing engine may support both spatial and semantic search. Spatial indexing may rely on hierarchical spatial subdivision techniques such as quadtrees or geohash-based tiling, enabling efficient retrieval of experiences located within a given radius or bounding box relative to a user's device position. Semantic indexing may employ keyword embeddings, tag clusters, or creator-defined categories that facilitate relevance-based retrieval even when specific geographic data are not provided.

To support large-scale public access, the system may implement a distributed architecture in which a primary database instance synchronizes with a read-optimized cache layer hosted within the cloud integration layer 190. This architecture may allow frequently queried entries—such as popular or high-rated experiences—to be served from geographically distributed edge nodes to minimize latency.

Each experience record may further include one or more linked assets, such as three-dimensional models, texture maps, animation data, or motion-capture sequences. These assets may be stored within a content delivery subsystem associated with the Output Subsystem 180 and referenced via asset pointers or secure content identifiers. The record may additionally include one or more interaction scripts that define behavioral logic or user-triggered events that are activated when the experience is initiated in the field.

In certain embodiments, the indexing logic may dynamically update based on user activity. For example, when a user completes an experience or provides a rating, the record's priority weight may be modified within the search ranking model. The ranking algorithm may also incorporate contextual factors such as time of day, event seasonality, or local traffic conditions. These dynamic indexing parameters may allow the database to serve both as a content catalog and as a context-adaptive discovery tool that evolves in real time.

The database may further integrate with geofencing modules and notification subsystems to automatically deliver localized alerts to users. For instance, when the user's device position corresponds to or intersects a stored geofence boundary associated with a database record, the system may automatically query the local cache to determine whether an experience is available nearby and may issue a proximity-based alert. This integration may allow continuous background discovery without requiring manual search input, while maintaining consistent alignment with spatial coordinate frameworks managed by the Pathway Engine 120 and Motion Graph Engine 130.

### Exemplary Use Scenarios

Industrial Maintenance: Sensors may overlay machine telemetry; avatars may instruct or warn users.

Healthcare: Biometric sensors may track movement; avatars may guide therapy exercises.

Education and Culture: Avatars may narrate museum exhibits or perform adaptive storytelling

Defense Training: Pathways may define tactical routes; haptics may convey impact feedback.

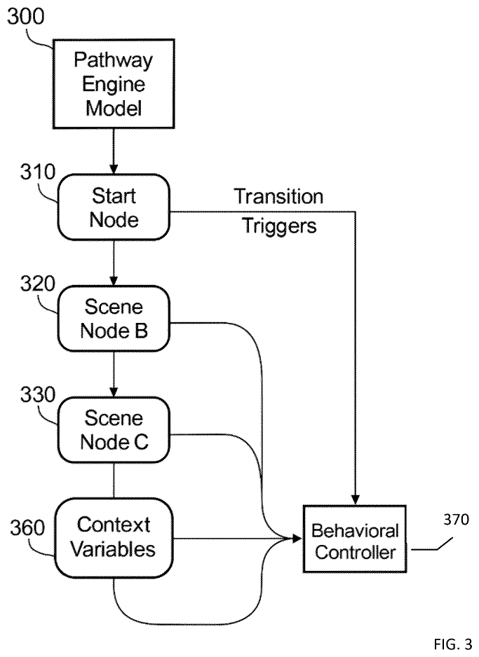

FIG. 3 illustrates a representative Pathway Engine model 300 depicting a set of linked scenes and conditional transitions. The model 300 may include a Start Node 310 corresponding to an initial environment or state. From the Start Node 310, one or more Scene Nodes 320, 330, 340 may define discrete augmented-reality environments, each associated with specific spatial anchors or user interactions. Transition Triggers 350 may define the logical conditions required to move from one scene to another, such as the user's location, elapsed time, or the recognition of a specific command. Context Variables 360 may persist between nodes and may represent evolving conditions such as task completion, conversation history, or environmental metrics. When a transition occurs, the Pathway Engine may output contextual data through an interface to a Behavioral Controller 370, enabling adaptive avatar behavior aligned with the new scene's semantic context.

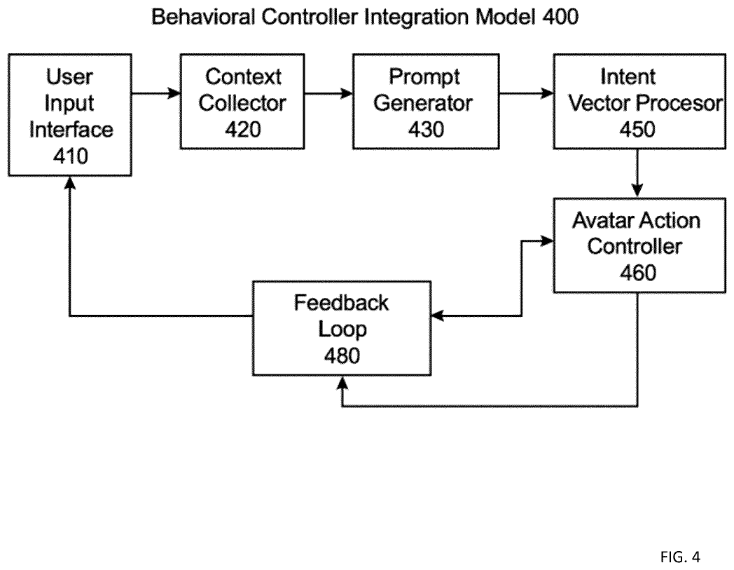

FIG. 4 illustrates a Behavioral Controller integration model 400. A User Input Interface 410 may capture multimodal input from a user. A Context Collector 420 may assemble recent dialogue, spatial metadata, and sensor readings. Based on that context, a Prompt Generator 430 may construct prompts for a Language Model Gateway 440. The model response may be parsed by an Intent Vector Processor 450 into normalized intent parameters that may drive an Avatar Action Controller 460. A Response Output Module 470 may coordinate audio, visual, and haptic output to the user device. A Feedback Loop 480 may route post-action state and user reactions back to the Context Collector 420 to adapt subsequent prompts and behavior.

### System Architecture Variants

The system may operate in centralized, decentralized, or hybrid architectures, balancing computation between cloud inference and on-device processing depending on privacy and bandwidth constraints.

### Implementation Framework and Exemplar Technical Architecture

In some embodiments, the system may be implemented using Unity 2021.3 LTS or later, integrated with AR Foundation and NavMeshComponents. The runtime may execute on devices supporting ARKit or ARCore and may employ platform-specific APIs for depth and point-cloud data.

A representative software architecture may include components for point-cloud scanning, mesh generation, navigation processing, avatar control, AI management, trigger handling, scene streaming, sensor normalization, state persistence, and networking synchronization.

### Point-Cloud Capture and Mesh Conversion

A PointCloudScanner may collect spatial points via ARPointCloudManager, merge updates, filter redundancies, and emit batches for conversion. A PointCloudToMesh converter may build surfaces using triangulation or Poisson reconstruction, while a NavMeshProcessor may bake navigable meshes asynchronously with Unity Jobs or Burst compilation.

### Avatar Control and Animation

An AvatarController may drive motion using NavMeshAgent, maintaining distance offsets relative to the user. An AvatarAnimatorAdapter may coordinate gestures and state transitions based on AI-generated actions.

### AI Action Management

An AIActionManager may queue prioritized behavioral events and may communicate with an AIConnector that performs asynchronous queries to a large-language-model service through a secure proxy. Responses may control speech, gesture, or narrative output.

### Trigger Zones and Scene Transitions

A TriggerZoneManager may monitor 3D trigger volumes and may invoke a SceneStreamer to load or unload scene segments corresponding to pathway nodes. Zones may link to geo-anchors or BLE beacons for persistent mapping.

### Sensor Fusion and Environmental Awareness

A SensorManager may combine data from BLE beacons, Wi-Fi positioning, and IMUs using extended Kalman filtering. Each input may carry a confidence metric that may adjust weighting in real time.

### State Persistence

A StatePersistence component may serialize session data—including avatar position and pathway progress—into local or cloud storage using JSON or SQLite formats, reloading them at startup.

### Networking and Multi-user Synchronization

A NetworkSync component may synchronize avatar positions, triggers, and anchors among clients using timestamped delta updates. Authority assignment and compression may minimize bandwidth.

### Pipeline Orchestration

A PipelineOrchestrator may coordinate updates from scanning to mesh conversion and navigation baking, ensuring avatars navigate newly mapped terrain without delay.

### Performance and Security

Mesh-baking may be throttled, predictive asset loading employed, and asynchronous execution maintained. Security features may include authenticated APIs and encrypted telemetry.

### Representative Operation

(1) Capture environment→(2) Generate mesh→(3) Detect triggers→(4) Query AI→(5) Render avatars→(6) Persist or sync state.

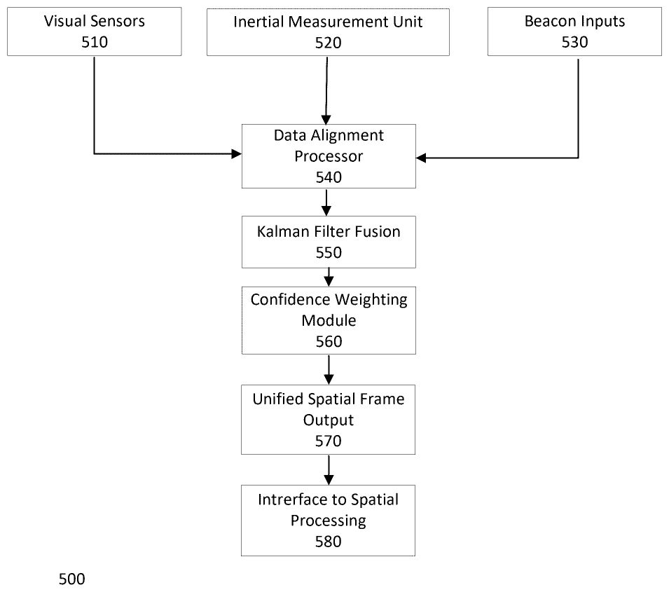

FIG. 5 is a block diagram illustrating an example of a sensor-fusion arrangement 500. A plurality of sensors may provide input data to the system, including Visual Sensors 510, an Inertial Measurement Unit 520, and Environmental Sensors 530. These inputs may be processed by an Alignment and Calibration Module 540 that may correct spatial offsets, normalize time stamps, and align data streams into a common temporal reference. A Kalman Filter Fusion Core 550 may combine the aligned data to produce a stable and drift-corrected representation of motion and environment. A Confidence Weighting Module 560 may compute reliability metrics for each input, dynamically adjusting fusion parameters in response to noise or signal degradation. The resulting fused data may be output through a Unified Spatial Frame Output 570 that may represent the system's consistent coordinate model of the surrounding environment. This fused output may be provided to the Spatial Processing Module via an Interface 580 for navigation-mesh generation, environmental mapping, and avatar positioning.

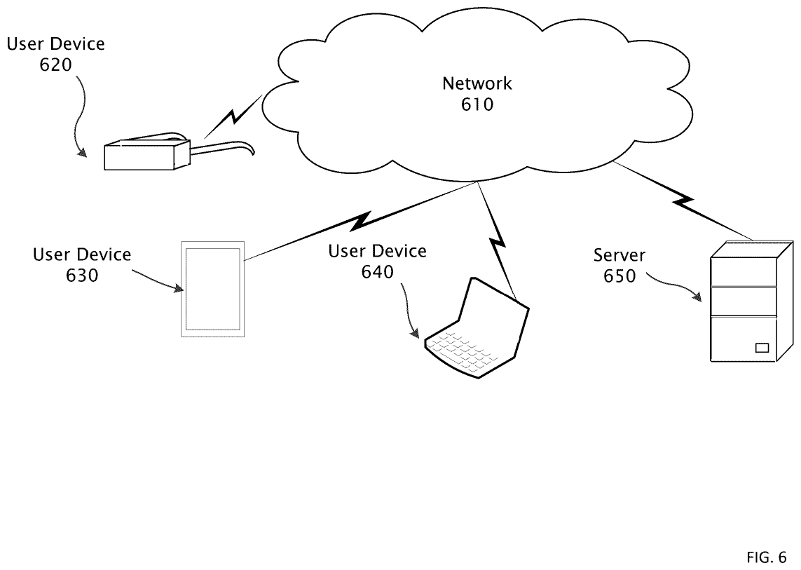

FIG. 6 is a block diagram illustrating an example of a system capable of supporting AR Ecosystems, according to one embodiment.

Network 610 may include Wi-Fi, cellular data access methods, such as 3G, 4G LTE, or 5G, Bluetooth, Near Field Communications (NFC), the internet, local area networks, wide area networks, or any combination of these or other means of providing data transfer capabilities. In one implementation, Network 610 may comprise Ethernet connectivity. In another implementation, Network 610 may comprise fiber optic connections.

User Device 620, 630, or 640 may have network capabilities to communicate with Server 650. Server 650 may include one or more computers and may serve several roles. Server 650 may be conventionally constructed or may be of a special-purpose design for processing data obtained from AR Ecosystems. One skilled in the art will recognize that Server 650 may have many different designs and capabilities.

Any of User Devices 620, 630, or 640 may be a VR Headset, a Smartphone, a tablet, a laptop, or any other type of device capable of running software, accessing a network, or storing content locally, providing GPS location services, and providing a user interface.

User Device 620, 630, or 640 may be used by tourists, for example, by accessing a website or executing an app. Server 650 may store and provide suggested points of interest, paths to visit one or more points of interest, and content to display on User Device 620, 630, or 640, for example. One skill in the art will recognize that various configurations for User Device 620, 630, or 640 and Server 650 may be used to implement AR Ecosystems.

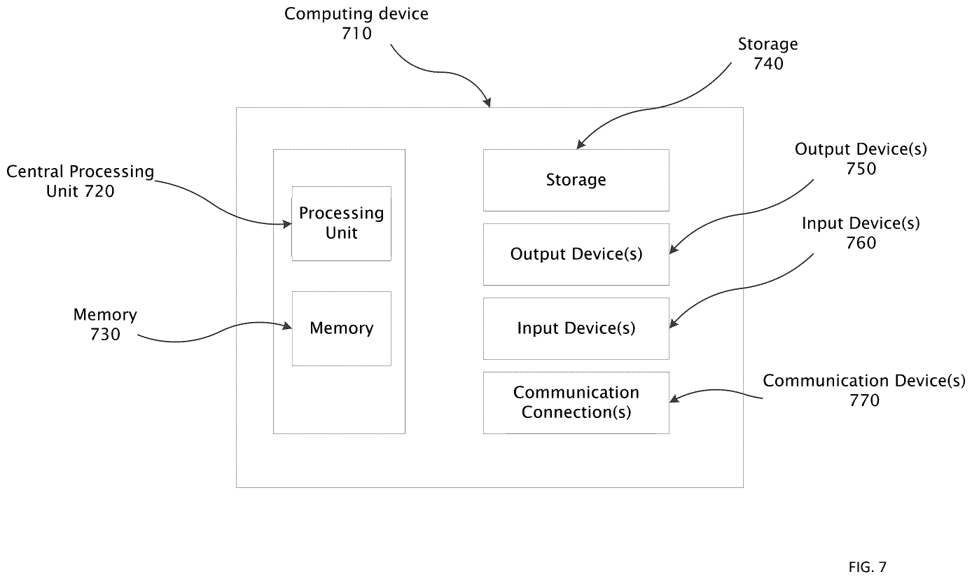

FIG. 7 is a component diagram of a computing device that may support AR Ecosystems, according to one embodiment. Computing Device 710 may be utilized to implement one or more computing devices, computer processes, or software modules described herein, including, for example, but not limited to, a mobile device, a Virtual Reality Headset, a server, a desktop computer, or other form factor. In one example, Computing Device 710 may process calculations, execute instructions, and receive and transmit digital signals. Computing Device 710 can be any general or special purpose computer now known or to become known capable of performing the steps or functions described herein, either in software, hardware, firmware, or a combination thereof. [00037] Computing Device 710 typically includes at least one Central Processing Unit (CPU) 720 and Memory 730 in its most basic configuration. Depending on the exact configuration and type of Computing Device 710, Memory 730 may be volatile (such as RAM), non-volatile (such as ROM, flash memory, etc.), or some combination of the two. Additionally, Computing Device 710 may also have additional features/functionality. For example, Computing Device 710 may include multiple CPUs. The described methods may be executed in any manner by any processing unit in Computing Device 710. For example, two CPUs may execute the described process in parallel.

Computing Device 710 may also include additional storage (removable or non-removable), including, but not limited to, magnetic or optical disks or tape. Such additional storage is illustrated by Storage 740. Computer-readable storage media includes volatile and non-volatile, removable, and non-removable media implemented in any method or technology for storing information, such as computer-readable instructions, data structures, program modules, or other data. Memory 730 and Storage 770 are all examples of computer-readable storage media. Computer-readable storage media includes but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by Computing Device 710. Any such computer-readable storage media may be part of Computing Device 710. But computer-readable storage media do not include transient signals.

Computing Device 710 may also contain Communications Device(s) 770, which allow the device to communicate with other devices.

Computing Device 710 may also have Input Device(s) 760, such as a keyboard, mouse, pen, voice input device, touch input device, GPS device, etc. Output Device(s) 750, such as a display, speakers, printer, etc., may also be included. Communications Device(s) 770 is an example of communication media. Communication media typically embody computer-readable instructions, data structures, program modules, or other data in a modulated data signal such as a carrier wave or other transport mechanism, and it includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art, all or a portion of the software instructions may be carried out by a dedicated circuit, such as a digital signal processor (DSP), programmable logic array, or the like. All these devices are well-known in the art and need not be discussed at length.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

The illustrated operations in the description also show events occurring in a particular order. In alternative implementations, certain operations may be performed in a different order, modified, or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A spatially aware avatar platform comprising:
a Spatial Processing Module that may capture environmental data and may generate a navigation mesh and semantic map;
a Pathway Engine that may define geospatially linked augmented-reality scenes, including asset bundles, triggers, and contextual variables;
a Motion Graph Engine that may control avatar locomotion based on the navigation mesh;
a Behavioral Controller that may interpret natural-language input and environmental metadata to determine avatar actions;
a Sensor Fusion Module that may align and combine data from multiple sensors within a common spatial frame;
an SDK Hub that may manage integration of third-party modules through authenticated interfaces; and
a Haptics Module that may generate tactile feedback synchronized with avatar behavior and environmental events.

2. The platform of claim 1, wherein the Spatial Processing Module may perform predictive asset streaming based on user trajectory or pathway transitions.

3. The platform of claim 1, wherein the Pathway Engine may implement a finite-state machine to manage transitions between scenes while maintaining continuity of contextual variables.

4. The platform of claim 1, wherein the Spatial Processing Module may perform semantic segmentation of objects using a neural network.

5. The platform of claim 1, wherein the Motion Graph Engine may employ reinforcement learning to refine animation blending.

6. The platform of claim 1, wherein the Behavioral Controller may maintain a persistent interaction record that may preserve conversational continuity across user sessions.

7. The platform of claim 1, wherein the Sensor Fusion Module may apply Kalman or particle filtering to correct positional drift.

8. The platform of claim 1, wherein the SDK Hub may enforce token-based authentication for each registered module and may rotate credentials periodically.

9. The platform of claim 1, wherein the Haptics Module may transmit vibration or force-feedback patterns via wireless communication protocols, including Bluetooth Low Energy or Wi-Fi.

10. The platform of claim 1, wherein the SDK Hub may include a graphical authoring environment that may allow developers to assemble pathway experiences through drag-and-drop node editing.

11. The platform of claim 1, wherein the platform may operate in multi-user environments and may synchronize avatar states across client and cloud devices through delta updates.

12. The platform of claim 1, wherein the platform may be deployed in industrial, educational, entertainment, or defense scenarios and may visualize real-time telemetry as augmented overlays aligned with physical structures.

13. A method for generating spatially aware avatar interaction in augmented reality, comprising:
capturing environmental geometry using one or more sensors;
constructing a navigation mesh and semantic map;
defining a pathway of linked spatial scenes;
determining user intent from natural-language input;
generating avatar actions based on pathway context and intent; and
rendering visual, auditory, and haptic feedback synchronized with environmental data.

14. The method of claim 13, further comprising fusing multiple sensor inputs to refine localization accuracy through weighted interpolation.

15. The method of claim 13, wherein the determining step may include generating intent tokens from a large-language-model gateway and mapping those tokens to avatar behavior categories.

16. The method of claim 13, further comprising preloading assets for predicted user pathways to reduce rendering latency.

17. The method of claim 13, wherein the rendering step may synchronize multimodal feedback through timestamp alignment and predictive correction.

18. A non-transitory computer-readable medium storing instructions that, when executed by one or more processors, may cause the processors to:
capture and process environmental data;
compute a navigation mesh;
fuse heterogeneous sensor inputs;
infer user intent from language input;
control avatar motion and dialogue; and
generate synchronized feedback signals.

19. The medium of claim 18, wherein the instructions may further cause encryption and authentication of inter-module communications.

20. The medium of claim 18, wherein the instructions may include logic for dynamic resource scaling based on available processing capacity or network bandwidth.
